(19) United States
(12) Patent Application Publication
(10) Pub. No.: US 2013/0054687 A1
(43) Pub. Date: Feb. 28, 2013

(54) ONLINE COMMUNITIES

(71) Applicant: Kareem DARWISH, Doha (QA)

(72) Inventor: Kareem DARWISH, Doha (QA)

(73) Assignee: Qatar Foundation, Doha (QA)

(21) Appl. No.: 13/218,828

(22) Filed: Aug. 26, 2011

(51) Int. Cl. G06F 15/16

(52) U.S. Cl. 709/204

(57) ABSTRACT

A method for creating a virtual hub for a community of users with common interests to interact in over a network, comprises determining multiple topical interests from a set of input sources queried over the network, computing a measure representing a prominence for respective ones of the multiple topical interests, providing a topical interest with a prominence value which exceeds a predetermined threshold for prominence, determining multiple interested parties for the topical interest using a measure of interest for users with respect to the topical interest, and instantiating a hub on the network for the topical interest for the multiple interested parties.

The present invention relates to online communities.

### BACKGROUND

People tend to coalesce around particular interests. These interests may be political orientations, ethnic or national issues, current events, etc. In some instances, people may form online groups through different services directed to the interests and in order to serve as a repository for related information and to act as a hub for like-minded individuals to congregate and share information and views.

Typically, such groups are relatively easy and inexpensive to form, but generally lack structure, consistency and organization. Further, in the face of transient events, it may not be possible for a group to be created as it would require at least one person to form it, and would require buy-in from the community in order to grow and evolve.

Some online communities or sites can be organized and consistent, but are—as a result—generally expensive to maintain. Further, such sites can require significant software sophistication and editorial effort. For example, website creation requires content management system.

### SUMMARY

According to an aspect of the present invention, there is provided a method for creating a virtual hub for a community of users with common interests to interact in over a network, comprising determining multiple topical interests from a set of input sources queried over the network, computing a measure representing a prominence for respective ones of the multiple topical interests, providing a topical interest with a prominence value which exceeds a predetermined threshold for prominence, determining multiple interested parties for the topical interest using a measure of interest for users with respect to the topical interest, and instantiating a hub on the network for the topical interest for the multiple interested parties. In an example, the method is an automated method for creating and/or augmenting an online community in the form of a virtual hub.

The set of input sources can be used to determine content for the topical interest, and the content used to augment the hub. In an example, the set of input sources can be used to determine content for the topical interest and provide a corresponding content recommendation to the multiple interested parties. The content can be content which was or is created by the multiple interested parties. Access to the hub over the network can be controlled by one or more of the multiple interested parties.

According to an aspect of the present invention, there is provided a system comprising a detection engine to determine multiple topical interests from a set of input sources queried over the network, a prominence detector to compute a measure representing a prominence for respective ones of the multiple topical interests and to provide a topical interest with a prominence value which exceeds a predetermined threshold for prominence, the system further to determine multiple interested parties for the topical interest using a measure of interest for users with respect to the topical interest, and instantiate, generate, create or otherwise provide a hub on the network for the topical interest for the multiple interested parties. The detection engine can determine content related to the topical interest from the input sources to augment the hub, and determine content for the topical interest and provide a corresponding content recommendation to the multiple interested parties using the set of input sources.

In an example, access to the hub over the network can be controlled for one or more of the multiple interested parties.

According to an aspect of the present invention, there is provided a computer program embedded on a non-transitory tangible computer readable storage medium, the computer program including machine readable instructions that, when executed by a processor, implement a method for creating an online community accessible over a network, comprising determining multiple topical interests from a set of input sources queried over the network, computing a measure representing a prominence for respective ones of the multiple topical interests, providing a topical interest with a prominence value which exceeds a predetermined threshold for prominence, determining multiple interested parties for the topical interest using a measure of interest for users with respect to the topical interest, and instantiating a community on the network for the topical interest for the multiple interested parties. The set of input sources can be used to determine content for the topical interest and augmenting the hub with the content, and to determine content for the topical interest and providing a corresponding content recommendation to the multiple interested parties.

### BRIEF DESCRIPTION OF THE DRAWINGS

FIG. 1 is a schematic block diagram of a system according to an example;

FIG. 2 is a flowchart of a method according to an example; and

FIG. 3 is a schematic block diagram of a system according to an example.

### DETAILED DESCRIPTION

According to an example, there is provided an automated system and method for creating community hubs. A community hub can be an online group, mailing list or dedicated website for example, where content can be automatically determined and created or manually selected and aggregated for users of the hub.

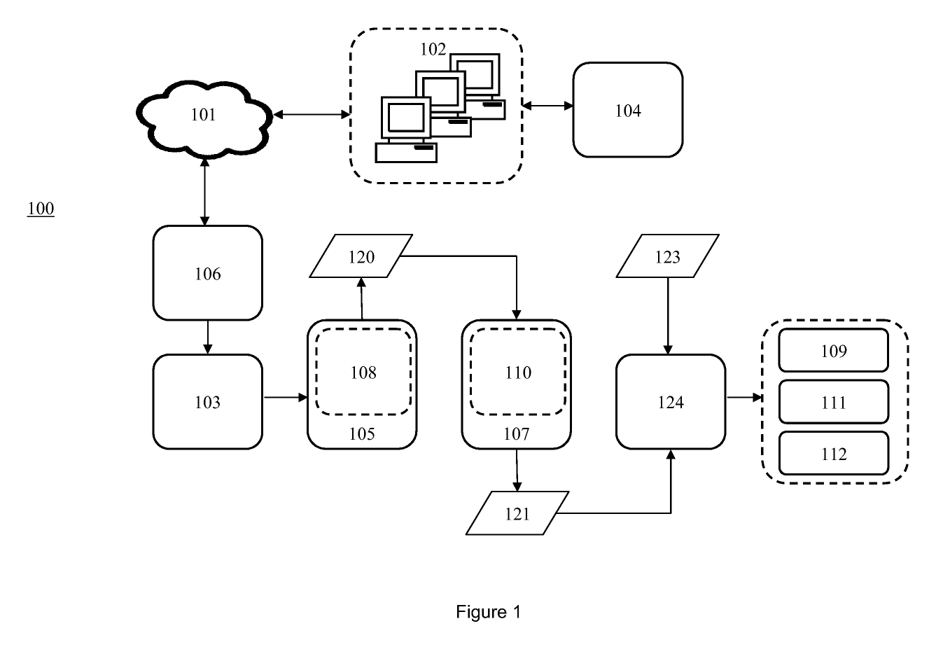

FIG. 1 is a schematic block diagram of a system according to an example. A network 101 can be any suitable network. In an example, network 101 is the internet. Accordingly, multiple users 104 connected to the network 101 can use their respective computing devices 102 to communicate with one another and upload/download data as desired. The users 104 can engage in the use of social media and social networking, such as blogging, micro-blogging, email and the use of social networking sites and so on, where, typically, user generated data is used to engage in social interaction such as in connection with the provision of interests and views. Such social media components 106 form a set of multiple input sources 103 according to an example.

Input sources 103 typically provide multiple data sources which can be used to mine information representing specific topics for the users 104. For example, blog and micro-blog postings, emails and information from social networking sites can be the source of information which is relevant for users 104 inasmuch as the information relates to one or more actual or potential interests of the users 104.

In block 105 topical interest detection is performed using a detection engine 108 to provide multiple topical interest elements 120. In an example, elements 120 include data representing blog and micro-blog postings, emails, information from social networking sites and other such social media data as well as data from other online services such as news triggers and recommendation systems. In fact, multiple different sources (including static or fixed data residing websites) can be used to provide data representing topical interest elements.

According to an example, content and structural information from input sources 103 can be used in order to determine topical interest elements 120. Typically, generative models can be used to generate observable data given some hidden parameters. For example, if observations are words collected into documents or other text sources which form part of the input sources 103, such models can be used to determine topics since each document will typically be a mixture of a small number of topics and each word's creation is attributable to one of the document's topics. Suitable techniques for determining the topics of input source data include Maximal Marginal Relevance (MMR), Latent Dirichlet Allocation (LDA), clustering (such as hierarchical or density based clustering for example), and binary classification (such as Support Vector Machines (SVM) for example). In an example, LDA can be used to automatically discover underlying latent (or hidden) topics for input sources 103.

In an example, a suitable process to determine and cluster topics from an input source 103 is described in: “Amr Ahmed, Qirong Ho, Alexander J. Smola, Choon Hui Teo, Jacob Eistenstein, Eric P. Xing. Unified Analysis of Streaming News, presented as part of WWW 2011—Session: Spatio-Temporal Analysis, Mar. 28-Apr. 1, 2011, Hyderabad, India”, the contents of which are incorporated herein by reference in their entirety. In another example, a technique which is suitable for determining topics from microblog postings is described in: “Xin Zhao, Jing Jiang, Jing He, Yang Song, Palakorn Achanauparp, Ee-Peng Lim and Xiaoming Li”, Topical keyphrase extraction from Twitter, In Proceedings of the 49th Annual Meeting of the Association for Computational Linguistics: Human Language Technologies, pages 379-388, 2011″, the contents of which are incorporated herein by reference in their entirety.

A basic approach determines underlying topics in a stream of documents or textual extracts from input sources 103 and computes a variety of conditional probabilities such as prob(topic|word) and prob(word|topic) along with the probabilities of a topic for example. Such an approach can generalize well over different articulations of a topic. For very short documents such as microblog posts or social network posts, documents can be assumed to be generated from just one topic.

Another content based topical detection in an example uses density based clustering, such as DBSCAN (Density-Based Spatial Clustering of Applications with Noise) which is a data clustering algorithm which finds a number of clusters starting from an estimated density distribution of corresponding nodes. Using DBSCAN, a distance can be computed between all documents. Such a distance can be obtained using a variety of methods such as a Cosine or Jaccard similarity for example. For a group of documents to be clustered together, they need to exceed a minimum number and have to be within a predefined (or learned) distance of each other. Once a group of documents fulfills these criteria, they are considered to represent a new topic.

In terms of structural analysis of content, there are several suitable methods that can analyze connections in a network. For example, in the context of hubs, users and documents can be considered as nodes and the connections (links) between nodes can include user activities relating to documents or other content. For example, some of these activities could include: explicit “likes” of documents or content, comments and shares of documents (email, social marks, shares in social media, etc.). In an example, using random walks or graph reinforcement on such a network, improved estimates of the coupling between users and content can be made. Using typical network separation techniques, clusters can then be created automatically. Such techniques can include min-cut (which would split a network into disjoint networks), degree centrality (where highly connected noted are considered as cluster cores), and singular value decomposition (which is a matrix dimensionality reduction in order to cluster nodes together).

In block 107 prominence detection is performed on topical interest elements 120 using a prominence detector 110. In an example, social network analysis can be used to compute a measure 121 representing the prominence of interests from the elements 120. The analysis can be used to determine a set of the users 104 who could be interested in and therefore associated with interests to provide a set of interested parties 109. In an example, prominence can be determined by using a measure representing the number of times a particular determined topic is present in data from input sources 103 for example.

A value 123 representing a prominence threshold is provided. The prominence measure 121 for respective ones of the elements 120 is compared to the measure 123 in block 124. If a measure 121 for an interest from the elements 120 exceeds the prominence threshold value 123, either: a virtual hub is formed around the interest in block 111 and related content is recommended to potentially interested parties 109; or a formal hub is suggested in block 112 to potentially interested parties 109 at which point they may elect to opt in for example. Alternatively, users could be assigned to a hub without their explicit opt-in being required. In an example, a listing of created hubs can be maintained, and content which is the subject of such hubs can be used as the basis to provide a recommendation to users who may have an interest in the topic of the hub. When a user makes a contribution (such as a blog post, blog, picture, social network post etc.), the contribution can be automatically assigned to the nearest hub (in terms of topic relevance and distance for example) to which a user is assigned. Alternatively, a hub can be suggested to the user, where the user may choose to opt-in or not.

According to an example, related content for a hub 111, 112 can be determined using a variety of retrieval, content filtering, and collaborative filtering techniques so that user contributions can be automatically assigned to a hub. Such related content can be use to populate or augment the content for a hub. For example, related content can be retrieved and used to populate a newly formed hub generated around a specific topic. Alternatively, retrieved content for a topic can be used to augment the content already available for a hub generated for that topic. Using the aforementioned techniques, given a user, users with similar interests can also be found. Alternatively, given a document, similar documents and users interested in these similar documents can be determined using. Accordingly, a generated hub can be populated with additional users and content, either or both of which can be automatically assigned or linked to a hub, or be the target of a recommendation to other users for example.

In an example, when documents are assigned to a particular latent topic of interest to a user, the document can be provided in a variety of ways, such as: an RSS feed where titles and summaries of documents of interest are provided; a link to content with a relevant URL and optional summary, or a thumbnail of a video or an image for example.

In an example, the tools can use existing online services such as news triggers, recommendation systems and social networking sites to either automatically assign or recommend content for a hub 111, 112. In an example, interested individuals may explicitly add content to a hub. For example, as they are browsing over the network 101 content can be flagged for addition to a hub.

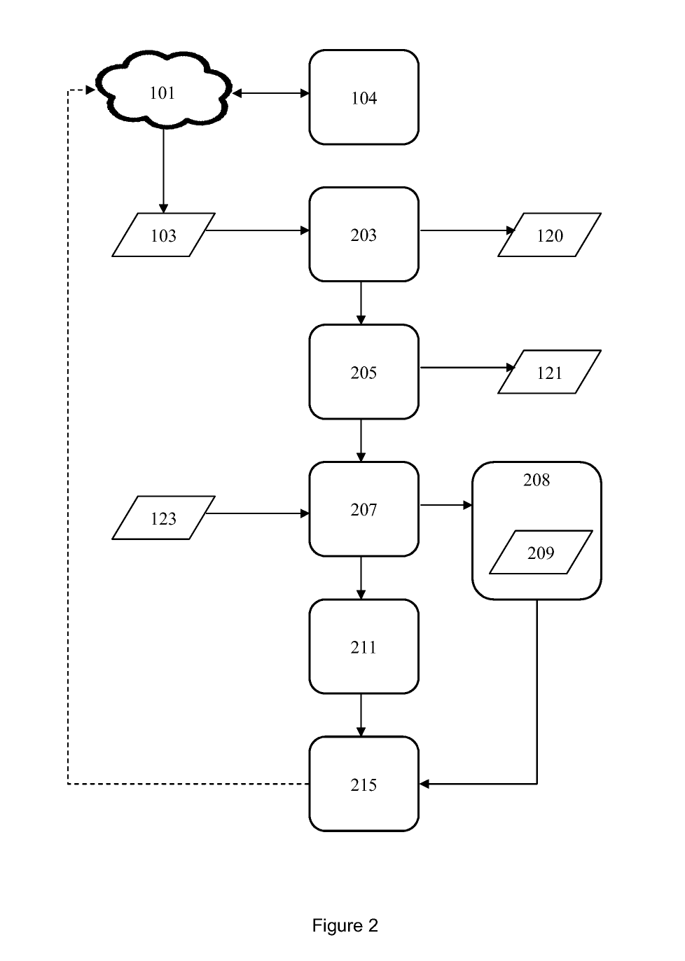

FIG. 2 is a flowchart of a method according to an example. A community of users 104 can interact with each other and content over a network 101. In an example, users 104 share a common interest. Accordingly, in block 203, multiple topical interests 120 from a set of input sources 103 queried over the network 101 are determined such as by using the techniques described above for example. In block 205 a measure 121 representing a prominence for respective ones of the multiple interests 120 is computed. The measure can be a simple numeric value representing the number of instances that a topic has been detected for example, or a measure based on the source of a detected topic—for example, certain sources can have a weighting value associated with them which provides a greater (or lesser) degree of prominence for topics determined from that source. For example, a certain website may have a relatively higher weighting value associated with it which means that topics determined from that website are given a higher rating for prominence. In block 207, a topical interest 208 with a prominence value 209 which exceeds a predetermined threshold 123 for prominence is selected. In block 213, multiple interested parties 211 for the topical interest 208 are determined using a measure of interest for users with respect to the topical interest. In block 215 a hub is created on the network 101 for the topical interest 208 for the multiple interested parties 211.

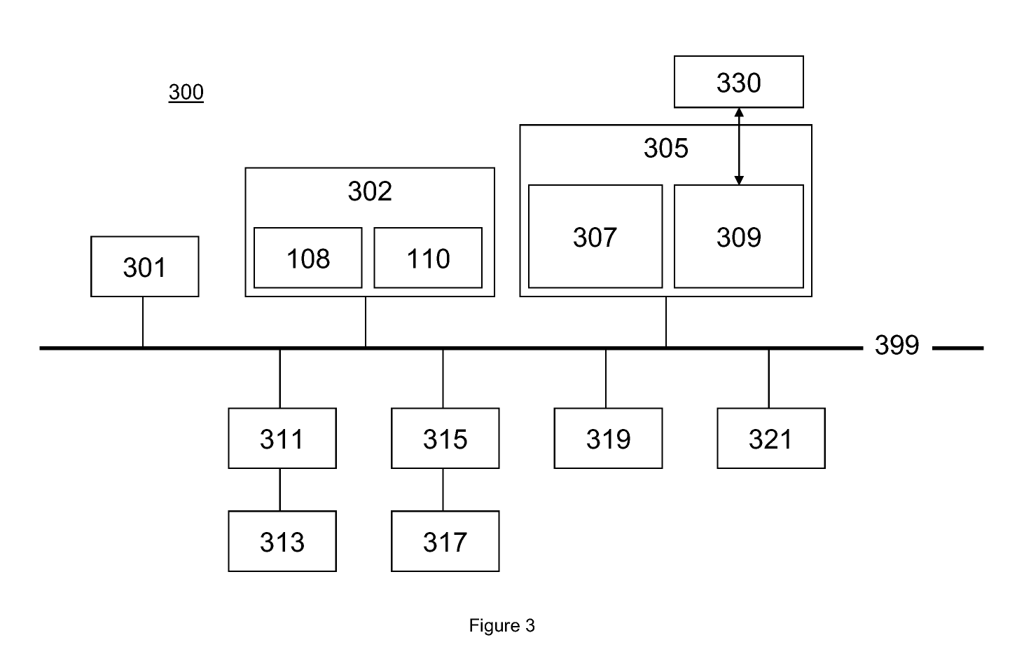

FIG. 3 is a schematic block diagram of a system according to an example, and which is suitable for implementing any of the systems, methods or processes described above. Apparatus 300 includes one or more processors, such as processor 301, providing an execution platform for executing machine readable instructions such as software. Commands and data from the processor 301 are communicated over a communication bus 399. The system 300 also includes a main memory 302, such as a Random Access Memory (RAM), where machine readable instructions may reside during runtime, and a secondary memory 305. The secondary memory 305 includes, for example, a hard disk drive 307 and/or a removable storage drive 330, representing a floppy diskette drive, a magnetic tape drive, a compact disk drive, etc., or a nonvolatile memory where a copy of the machine readable instructions or software may be stored. The secondary memory 305 may also include ROM (read only memory), EPROM (erasable, programmable ROM), EEPROM (electrically erasable, programmable ROM). In addition to software, data representing any one or more of input sources 103, topical elements 120, prominence measures 121 and thresholds 123 may be stored in the main memory 302 and/or the secondary memory 305. The removable storage drive 330 reads from and/or writes to a removable storage unit 309 in a well-known manner.

A user can interface with the system 300 with one or more input devices 311, such as a keyboard, a mouse, a stylus, and the like in order to provide user input data for example. The display adaptor 315 interfaces with the communication bus 399 and the display 317 and receives display data from the processor 301 and converts the display data into display commands for the display 317. A network interface 319 is provided for communicating with other systems and devices via a network such as network 101 for example. The system can include a wireless interface 321 for communicating with wireless devices in the wireless community.

It will be apparent to one of ordinary skill in the art that one or more of the components of the system 300 may not be included and/or other components may be added as is known in the art. The system 300 shown in FIG. 3 is provided as an example of a possible platform that may be used, and other types of platforms may be used as is known in the art. One or more of the steps described above may be implemented as instructions embedded on a computer readable medium and executed on the system 300. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

According to an example, a detection engine 108 can reside in memory 302 and operate on data from input sources 103 to provide a set of topical interest elements 120. Further, a prominence detector 110 can reside in memory 302 and operate on data representing topical elements 120 to provide a measure for prominence 121.

What is claimed is:

1. A method for creating a virtual hub for a community of users with common interests to interact in over a network, comprising:
determining multiple topical interests from a set of input sources queried over the network;
computing a measure representing a prominence for respective ones of the multiple topical interests;
providing a topical interest with a prominence value which exceeds a predetermined threshold for prominence;
determining multiple interested parties for the topical interest using a measure of interest for users with respect to the topical interest; and
instantiating a hub on the network for the topical interest for the multiple interested parties.

2. A method as claimed in claim 1, further comprising using the set of input sources to determine content for the topical interest and augmenting the hub with the content.

3. A method as claimed in claim 1, further comprising using the set of input sources to determine content for the topical interest and providing a corresponding content recommendation to the multiple interested parties.

4. A method as claimed in claim 1, further comprising using the set of input sources to determine content for the topical interest and augmenting the hub with the content, wherein the content is content which was or is created by the multiple interested parties.

5. A method as claimed in claim 1, wherein access to the hub over the network can be controlled by one or more of the multiple interested parties.

6. A system comprising:
a detection engine operable to determine multiple topical interests from a set of input sources queried over the network;
a prominence detector operable to compute a measure representing a prominence for respective ones of the multiple topical interests and to provide a topical interest with a prominence value which exceeds a predetermined threshold for prominence;
wherein the system is operable to:
determine multiple interested parties for the topical interest using a measure of interest for users with respect to the topical interest; and
instantiate a hub on the network for the topical interest for the multiple interested parties.

7. A system as claimed in claim 6, wherein the detection engine is further operable to determine content related to the topical interest from the input sources to augment the hub.

8. A system as claimed in claim 6, wherein the detection engine is operable to determine content for the topical interest and provide a corresponding content recommendation to the multiple interested parties using the set of input sources.

9. A system as claimed in claim 6, being further operable to control access to the hub over the network for one or more of the multiple interested parties.

10. A computer program embedded on a non-transitory tangible computer readable storage medium, the computer program including machine readable instructions that, when executed by a processor, implement a method for creating an online community accessible over a network, comprising:
determining multiple topical interests from a set of input sources queried over the network;
computing a measure representing a prominence for respective ones of the multiple topical interests;
providing a topical interest with a prominence value which exceeds a predetermined threshold for prominence;
determining multiple interested parties for the topical interest using a measure of interest for users with respect to the topical interest; and
instantiating a community on the network for the topical interest for the multiple interested parties.

11. A method for creating an online community accessible over a network as claimed in claim 10, further comprising using the set of input sources to determine content for the topical interest and augmenting the hub with the content.

12. A method for creating an online community accessible over a network as claimed in claim 10, further comprising using the set of input sources to determine content for the topical interest and providing a corresponding content recommendation to the multiple interested parties.

13. A method for creating an online community accessible over a network as claimed in claim 10, wherein the content is content which was or is created by the multiple interested parties.

14. A method for creating an online community accessible over a network as claimed in claim 10, wherein access to the hub over the network can be controlled by one or more of the multiple interested parties.
